(19) United States
(12) Patent Application Publication
(10) Pub. No.: US 2009/0175177 A1
(43) Pub. Date: Jul. 9, 2009

(54) METHOD FOR TESTING A WIRELESS NETWORK DEVICE

(75) Inventor: Paul Schwann, Styria (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/281,567

(22) PCT Filed: Feb. 13, 2007
(86) PCT No.: PCT/IB2007/050470

§ 371 Date: Sep. 3, 2008

(30) Foreign Application Priority Data
Mar. 6, 2006 (EP) 06110698.5

(51) Int. Cl. H04J 1/16

(52) U.S. Cl. 370/250

(57) ABSTRACT

The invention relates to a method and a system for testing a wireless network device (1) connected to a communication channel (3), whereby:—a testing computer (2) connected to the communication channel (3) starts a test function;—the wireless network device (1) starts a unifying testing module being adapted to a hardware constellation of said wireless network device (1) and/or an operating system running on said wireless network device (1) and providing an application programming interface connected to said communication channel (3) and being independent of said hardware constellation and/or said operating system;—said test function sends at least one command to said unifying testing module at least via said communication channel (3) and said application programming interface; and—said unifying testing module executes said command from the test function and sends at least a status of execution of said command back to the test function at least via the application programming interface and said communication channel (3).

### FIELD OF THE INVENTION

The invention relates to a method for testing, including monitoring and/or controlling a wireless network device, especially a mobile phone, a pocket PC.

### BACKGROUND OF THE INVENTION

In general, wireless network devices, such as electronic devices, pocket PCs, mobile phones, digital cameras, are part of wireless local area networks, such as wireless enterprise networks or wireless public networks. In order to meet the requirements of wireless local area networks, test tools are necessary to solve WLAN problems and to monitor WLAN communication.

Usually, a variety of general RF and software tools, such as spectrum analysers and listen-only protocol analysers test the conformance of the wireless networks and the wireless network device according to the 802.11 protocol. The well-known spectrum analysers or protocol analysers cannot be shared throughout the different wireless network devices with different hardware constellation and different operating systems. As a consequence, special testing programs are developed for different WLAN devices and their different hardware constellations and their different operating systems.

### OBJECT AND SUMMARY OF THE INVENTION

The object of the present invention is to provide an improved method and a system for testing a wireless network device.

Accordingly, the method disclosed herein provides a method for testing and/or monitoring and/or controlling a wireless network device, such as a mobile phone, a PDA, a smart phone, a printer or another embedded system, connected to a communication channel. The communication channel can be wired or wireless, e.g. an Ethernet, USB, IEEE 1394, Bluetooth or WLAN connection.

A test function is run on a testing computer connected to the communication channel. The test function can be automated, so it does not need much input from an operator. A unifying test module is run on the wireless network device, the unifying test module being adapted to a hardware constellation of the wireless network device and/or an operating system running on the wireless network device and providing an application programming interface connected to the communication channel and being independent of the hardware constellation and/or the operating system. The unifying test module may be started automatically every time the wireless network device is switched on or manually by an operator. The test function is configured to connect to the unifying test module and sends a command to it via the communication channel and the application programming interface. The unifying test module executes the command in a manner specific to the particular wireless network device and sends at least a status of execution of the command back to the test function via the application programming interface and the communication channel. Thus the test function can test, monitor and control the wireless network device without needing any knowledge of its hardware constellation or the operating system run on it, so the test function can stay unchanged when a vendor releases a new wireless network device. Only the software module has to be adapted anew in this case.

Some commands require one or more arguments to be sent with them in order to change settings or the like.

In some cases returning measurement results to the test function in addition to or instead of the status of execution of the command, e.g. when measuring data rates, is more meaningful.

In order to give the operator a quick overview, the test function can build a report out of the status of execution and/or the measurement result received due to a command. Summarising two or more such statuses ore results is even more useful.

The commands sent by the test function can comprise the following:
activate or deactivate the wireless network device and/or its connection means to a wireless network. When activating, a MAC (media access control) address can be assigned. Deactivating does not require arguments.
configure and/or monitor the wireless network device. A multitude of settings, such as channel, transmit data rate, SSID (service set identifier), working mode (“ad hoc” or “managed” ), BSS/IBSS (basic service set/independent basic service set), encryption setting (WEP, WPA, etc.; “open” or “shared”), power saving mode (OFF, FAST—wake up for every beacon, MAX—wake up every DTIM-beacon), device status (associated, not associated—doing something else than scan) can be configured or monitored.
receive and/or transmit data to at least one other device connected directly or indirectly to the wireless network. Data can be transmitted and or received using e.g. one of the protocols TCP/IP (Transmission Control Protocol/Internet Protocol) or UDP (User Datagram Protocol) or another protocol. Transmitting TCP/IP packets requires more arguments: a remote address, a port and a length of time to be sent as arguments. Transmitting UDP packets requires a remote address, a port, minimum, maximum and stepwidth of packet length, number of packets and delay time between packets. Receiving TCP/IP or UDP packets requires a local port for receiving and the time length as arguments. A successful transmit/receive session will result in the following measurement results returned: a total number of bytes received and/or transmitted and a time actually needed for transmitting and/or receiving.

In an advantageous embodiment of the invention the data received or transmitted via the wireless network are monitored and/or analysed by a sniffer device. This can be a computer connected to the wireless network, monitoring the data traffic and analysing, if the transmitted data are corrupted.

### BRIEF DESCRIPTION OF THE DRAWINGS

The method for testing and/or monitoring and/or controlling a wireless network device will now be described in detail with reference to the accompanying drawings, in which:

FIG. 1 is a schematic of a test arrangement for testing and/or monitoring and/or controlling a wireless network device.

### DESCRIPTION OF EMBODIMENTS

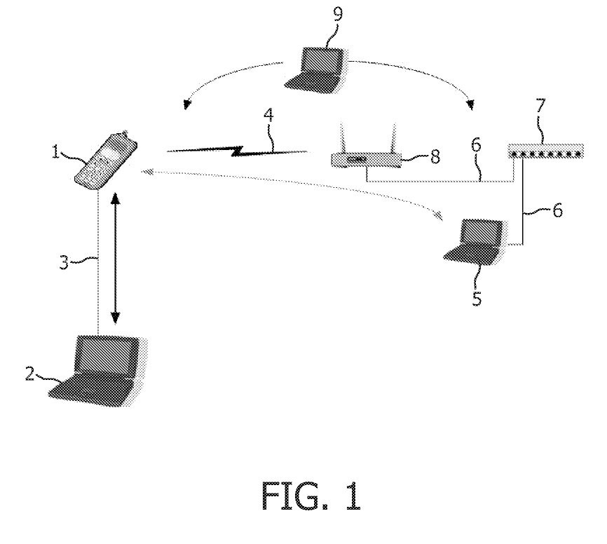

FIG. 1 shows a test arrangement for testing and/or monitoring and/or controlling a wireless network device 1, which is a mobile phone in this case, but can be any other wireless network device, such as a PDA, a smart phone, a printer or another embedded system.

The wireless network device 1 is connected to a testing computer 2 via a communication channel 3, which can be e.g. an Ethernet, USB, IEEE1394, Bluetooth or WLAN connection or the like.

The wireless network device 1 is also connected to a wireless network 4, e.g. a WLAN to enable it to transmit and receive data to and from one other device 5. This other device is connected indirectly to the wireless network 4 via an Ethernet cable 6, an Ethernet hub 7 and a WLAN hub 8. It could likewise be connected another way, especially directly to the wireless network 4, e.g. by means of a built in WLAN device. The wireless network device 1 could comprise a slot for connecting a WLAN device or an integrated WLAN device.

A sniffer device 9, a laptop computer in this case, is also connected to the wireless network.

A unifying test module is started on the wireless network device 1. The unifying test module is adapted to a hardware constellation of the wireless network device 1 and/or an operating system running on the wireless network device 1 and provides an application programming interface connected to the communication channel 3 and being independent of the hardware constellation and/or the operating system.

On the testing computer 2 a test function is started. The test function is configured to connect to the unifying test module and sends commands with respective arguments to it via the communication channel 3 and the application programming interface.

The unifying test module executes the command in a manner specific to the wireless network device 1 and sends a status of execution of the command and a measurement result back to the test function via the application programming interface and the communication channel 3. Thus the wireless network device 1 or its connection to the wireless network can be configured or switched on or off.

Some special commands can cause the wireless network device 1 to receive and/or transmit data via the wireless network 4, the WLAN hub 8, the Ethernet hub 7 and the Ethernet cable 6 from and/or to the other device 5. In this case the measurement results returned to the test function contain information on the total number of bytes received and/or transmitted and the time actually needed for transmitting and/or receiving. The sniffer device 9 can monitor the data traffic between the wireless network device 1 and the other device 5. It can e.g. analyse data corruption.

The unifying test module could likewise be plugged into the test function and thus hosted inside the testing computer 2, so the unified application programming interface would be there, too. This would allow using vendor determined protocols on the communication channel 3 while preserving the advantage of avoiding the need to modify the test function.

1. A method for testing a wireless network device connected to a communication channel, comprising:
starting a test function on a testing computer connected to the communication channel;
starting a unifying test module on the wireless network device, the unifying test module being adapted to a hardware constellation of the wireless network device and/or an operating system running on the wireless network device and providing an application programming interface connected to the communication channel and being independent of the hardware constellation and/or the operating system;
sending at least one command from the test function to the unifying test module at least via the communication channel and the application programming interface; and
executing the command by the unifying test module and sending at least a status of execution of the command from the unifying test module to the test function at least via the application programming interface and the communication channel.

2. The method according to claim 1, characterised in, that the test function sends at least one argument associated to the command to the unifying test module.

3. The method according claim 1, characterised in, that the unifying test module sends at least one measurement result to the test function.

4. The method according to claim 1, characterised in, that the test function builds a report of at least one status of execution and/or one measurement result received.

5. The method according claim 1, characterised in, that the command can activate or deactivate the wireless network device and/or a connection between the wireless network device and a wireless network.

6. The method according to claim 1, characterised in, that the command can configure and/or monitor the wireless network device.

7. The method according to claim 1, characterised in, that the command can cause the wireless network device to receive and/or transmit data via the wireless network from and/or to at least one other device connected directly or indirectly to the wireless network.

8. The method according to claim 7, characterised in, that the data received or transmitted via the wireless network are monitored and/or analysed by a sniffer device directly or indirectly connected to the wireless network.

9. A system for testing a wireless network device connected to a communication channel, whereby:
a testing computer connected to the communication channel starts a test function;
the wireless network device starts a unifying testing module being adapted to a hardware constellation of said wireless network device and/or an operating system running on said wireless network device and providing an application programming interface connected to said communication channel and being independent of said hardware constellation and/or said operating system;
said test function sends at least one command to said unifying testing module at least via said communication channel and said application programming interface; and
said unifying testing module executes said command from the test function and sends at least a status of execution of said command back to the test function at least via the application programming interface and said communication channel.
